(19) United States
(12) Patent Application Publication
(10) Pub. No.: US 2009/0106839 A1
(43) Pub. Date: Apr. 23, 2009

(54) METHOD FOR DETECTING NETWORK ATTACK BASED ON TIME SERIES MODEL USING THE TREND FILTERING

(76) Inventors: Myeong-Seok Cha, Uiwang-si (KR); Won-Tae Sim, Seongnam-si (KR); Woo-Han Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 11/941,215

(22) Filed: Nov. 16, 2007

(30) Foreign Application Priority Data
Oct. 23, 2007 (KR) 10-2007-0106782

(51) Int. Cl. G06F 21/00

(52) U.S. Cl. 726/23

(57) ABSTRACT

Method for detecting network attack based on time series model using the trend filtering. The method has the steps of: a) removing a trend component from the time series data to extract a residual component; and b) detecting an anomaly by applying a time series model to the residual component.

### CROSS-REFERENCE TO RELATED APPLICATION

This application claims all benefits of Korean Patent Application No. 10-2007-0106782 filed on Oct. 23, 2007 in the Korean Intellectual Property Office, the disclosures of which are incorporated herein by reference.

### BACKGROUND OF THE INVENTION

1. Field of the Invention

The present invention relates to a method for detecting network attacks; and, more particularly, to a method for detecting network attacks by removing a trend component that is less related to the network attack from time series data through the trend filtering, thereby not only minimizing errors of predictions but also detecting network attacks simply and accurately.

2. Description of the Prior Art

To protect information system against advances in security threats, many enterprises are now enterprise-widely and intergratedly operating a variety of security solutions such as firewall, virus wall, IDS, and IPS, based on ESM (Enterprise Security Management) system. Also, a necessity has been arisen to detect a zero-day attack using unknown software flaws/vulnerabilities. Recently, a new IDS has appeared on the market for anomaly detection, which uses a behavior analysis in a current protocol and a network traffic rate. An increase in the complexity of security management brought a number of problems. It is evident that a flood of security events due to a false positive, a major issue among them, is a serious problem in that it can override a generally used signature-based IDS or IPS as well as security infrastructure, as indicated by the Gartner group.

As data to be dealt with in a time series analysis are observed sequentially over time, they are naturally time dependent. Particularly, the data being observed over equal time increments are called time series data. One of properties of the time series data is that things being observed at a certain point are dependent on previously observed ones. A time series data includes an irregular component and a trend component, and the trend component may be categorized into a linear trend component, a seasonal component, and a cyclical component. The irregular component is fluctuation caused by unknown cause, irrespective of time-dependent regular movement. Particularly, a fluctuation component in case that observation values tend to continuously increase or decrease as time elapses is called the linear trend component. In some cases, a time series data fluctuates by seasons rather than time. Such fluctuation caused by a periodic change in season is called the seasonal component. Meanwhile, there is a long-period fluctuation called the cyclical component, which shows a periodic change similar to the seasonal component but its period is longer than a season.

In general, network operators observe a histogram of network traffic statistical data through NMS (Network Management System) to detect network anomalies, and depend on their experiences to judge the anomaly phenomenon. A commercial NMS uses SNMP to query and receive MIB (Management Information Base) data from network equipment, and sets up simple rules using a threshold value to identify a network anomaly. However, setting such rules is heavily dependent on personal experiences of a network operator and causes a lot of errors because of that.

Further, it is quite complicated to predict (or forecast) the linear trend, seasonal trend, and cyclic trend components of the time series data, and considerable errors of predictions are made during the prediction.

### SUMMARY OF THE INVENTION

It is, therefore, an object of the present invention to provide a network attack detection method featuring a high accuracy with minimum false-positive and false-negative errors.

Another object of the present invention is to provide a simplified, accurate network attack detection method, wherein a normal network traffic behavior model is developed, an anomaly in any phenomenon that violates the model is identified, and a linear trend component, a seasonal trend component, and a cyclic trend component are filtered and removed from a time series data.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

In accordance with an aspect of the present invention, there is provided a method for detecting a network attack, including the steps of: a) removing a trend component from the time series data to extract a residual component; and b) detecting an anomaly by applying a time series model to the residual component.

In the step a), the trend component may be removed by using a signal filter, and the signal filter is preferably a high-pass filter.

The step b) may include the steps of: b1) calculating a confidence limit around a predicted value of the time series model to set a normal range; and b2) acknowledging the existence of an anomaly if the time series of the residual component falls outside the normal range.

The time series model is preferably an ARMA model.

In an exemplary embodiment, the method further includes, between the trend component removing step a) and the anomaly detecting step b), the steps of: analyzing a constant variance over time of the time series of the residual component to select a time series model; and determining a parameter for the time series model based on ACF (Autocorrelation Function) and PACF (Partial Autocorrelation Function).

According to the network attack detection method of the present invention, a simple yet highly accurate detection of network attacks may be carried out by developing a normal network traffic behavior model, identifying an anomaly in any phenomenon that violates the model, and filtering/removing a linear trend component, a seasonal trend component, and a cyclic trend component from a time series data.

### BRIEF DESCRIPTION OF THE DRAWINGS

FIG. 1 is a flow chart describing a method for detecting a network attack, according to one embodiment of the present invention.

FIG. 2 is a graph illustrating a network traffic time series.

FIG. 3 is a graph illustrating a network traffic data in an original time series.

FIG. 4 is a graph illustrating an output result (signal) of a network traffic data time series by a high pass filter.

FIG. 5 is a graph illustrating an autocorrelation distribution of a residual component in a time series.

FIG. 6 is a graph illustrating a partial autocorrelation distribution of a residual component in a time series.

FIG. 7 is a graph illustrating ISP network traffic data as a test target.

FIG. 8 is a result graph illustrating part of the ISP network traffic data of FIG. 7 filtered by a high pass filter according to one embodiment of the present invention.

FIG. 9 is a graph illustrating a normal range set up by an ARMA model according to one embodiment of the present invention.

FIG. 10 is another example of a result graph illustrating part of the ISP network traffic data of FIG. 7 filtered by a high pass filter according to one embodiment of the present invention.

FIG. 11 is another example of a graph illustrating a normal range set up by an ARMA model according to one embodiment of the present invention.

### DETAILED DESCRIPTION OF EMBODIMENTS

The advantages, features and aspects of the invention will become apparent from the following description of the embodiments with reference to the accompanying drawings, which is set forth hereinafter.

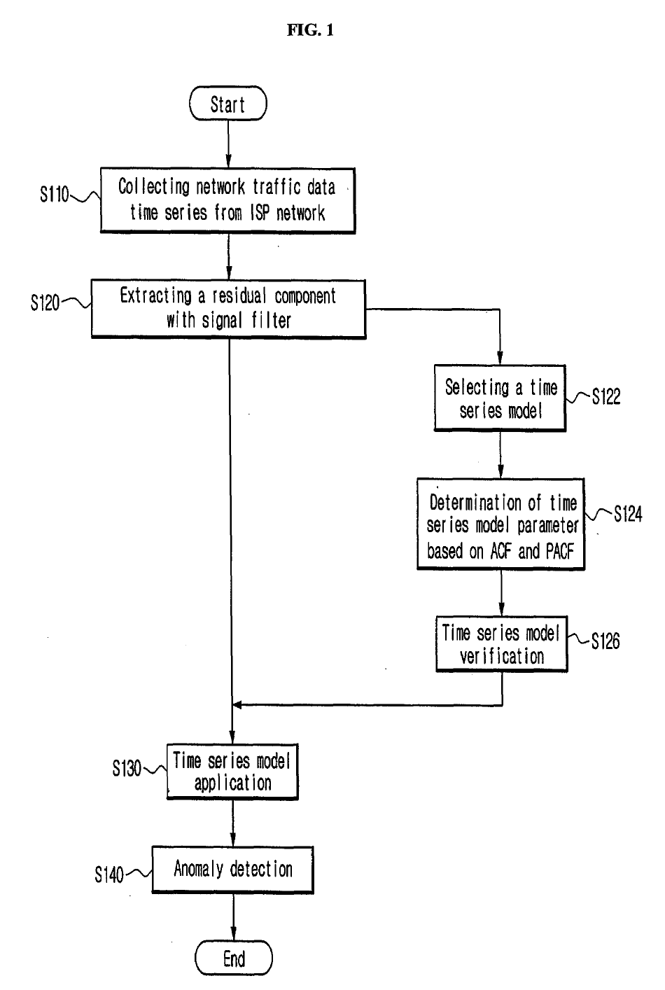

FIG. 1 is a flow chart describing a method for detecting a network attack, according to one embodiment of the present invention.

Referring to FIG. 1, a time series of a network traffic data, a target for an attack detection operation, is collected from an ISP (Internet Service Provider) network (S110).

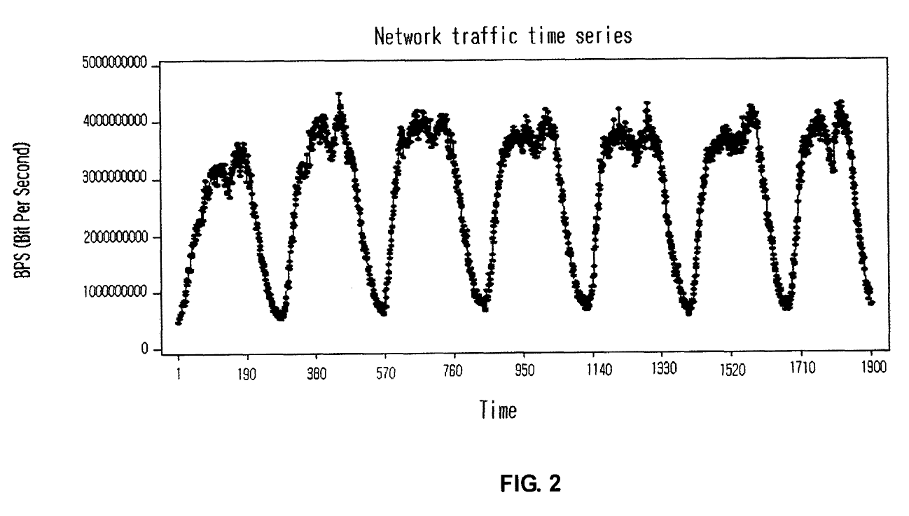

FIG. 2 is a graph illustrating a network traffic time series. For example, it is collected on IX (Internet eXchange) section of a Korean ISP backbone, an international section, and links of an internal section. Each link collects BPS (Bits Per-Second) and PPS (Packet Per-Second) data every 5-minute period and stores them in an Oracle database for use in an analysis.

As can be seen from the graph, the network traffic starts increasing gradually every day in the morning and decreases in the evening with the lowest point at dawn. Such phenomenon tends to repeat every single day. Therefore, the network BPS/PPS data are scalar observations recorded over equal time increments, and may be defined as a univariate time series which is influenced by time only.

As shown in FIG. 2, the time series exhibits a similar cyclic trend every day, and such a trend component is so difficult to be predicted that many network operators make prediction errors in time series.

Going back to FIG. 1, after the network traffic data time series is collected (S110), it is filtered by a signal filter to remove the trend component (S120).

A time series of network traffic data is composed of two sub-divisions including a residual component and a trend component. The trend component includes a cyclical trend, a seasonal trend and a linear trend.

A network attack has a characteristic that affects network traffic within a short amount of time. Such phenomenon is seen in a residual component of a network traffic data time series. As discussed earlier, a part for forecasting a trend component is a major factor that causes errors in prediction and increases complexity. According to the present invention, however, the trend component is removed by a signal filter to be able to detect an anomaly through a time series analysis model for the residual component.

Signal filters may be categorized into high-pass filters, band-pass filters, and low-pass filters. In the interest of brevity, the following will now explain a method for extracting a residual component by using a high-pass filter. One should note that the present invention is not limited thereto, but the other filters, e.g., the band-pass filter or the low-pass filter, may also be used for extraction of a residual component.

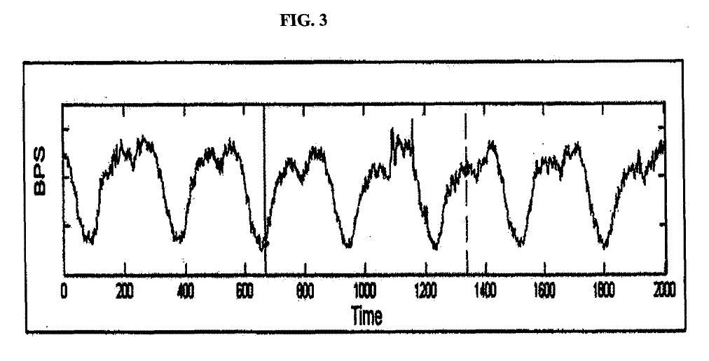

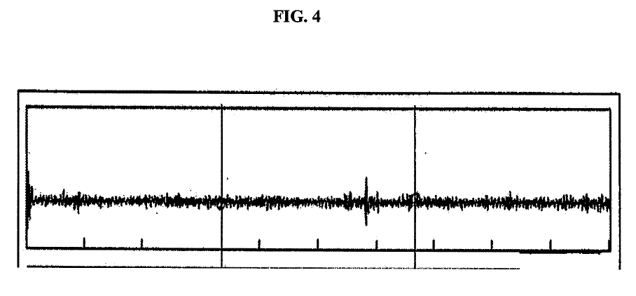

FIG. 3 is a graph illustrating a network traffic data in an original time series, and FIG. 4 is a graph illustrating an output result (signal) of a network traffic data time series by a high pass filter.

Examples of the high-pass filter include, but are not limited to, a butterworth filter, a chebyshev filter, and an elliptic filter. The butterworth filter has the smallest output of roll-off for a network traffic time series, and is represented by the following equation.

$${G}^{2} ( ω ) = {\vert H ( jω ) \vert}^{2} = \frac{{G}_{0}^{2}}{1 + {( \frac{{ω}_{c}}{ω} )}^{2 n}} \qquad [ Equation 1 ]$$

Here, n indicates an order of the filter, ω_{c} indicates a cutoff frequency, and G₀ indicates a DC gain.

After the residual component of the network traffic data time series is extracted by using the signal filter (S120), an appropriate time series model is selected based on an analysis of the properties of the residual component time series (S122). The residual component time series has the property that it exhibits normality without trend yet a constant variance over time. There is no specific limit to the model for the time series forecasting, and an ARMA (Auto Regressive and Moving Average) model for example may be adopted for the short time forecasting.

The ARMA model is represented by the following equation.

yₜ=α₁yₜ₋₁+α₂yₜ₋₂+ . . . +α_{q}y_{t-q}+δₜ+β₁δₜ₋₁+β₂δₜ₋₂+ . . . +βₚδₜ₋ₚ [Equation 2]

Here, αₜ indicates a modulus of AR (Auto Regressive), βₜ indicates a modulus of MA (Moving Average), yₜ indicates an ARMA process, and, δₜ indicates a white noise.

In general, the ARMA model is expressed in terms of ARMA (p,q), where p is the order of AR and q is the order of MA.

These two orders ‘p’ and ‘q’ are determined based on ACF (Autocorrelation Function) and PACF (Partial Autocorrelation Function). Here, ACF is a correlation function between the time series yₜ and yₜ₋ₖ while PACF is a correlation function between yₜ and yₜ₋ₖ after removing the inter-correlation of yₜ₋₁, yₜ₋₂, . . . , yₜ₋ₖ₋₁ existing between yₜ and yₜ₋ₖ.

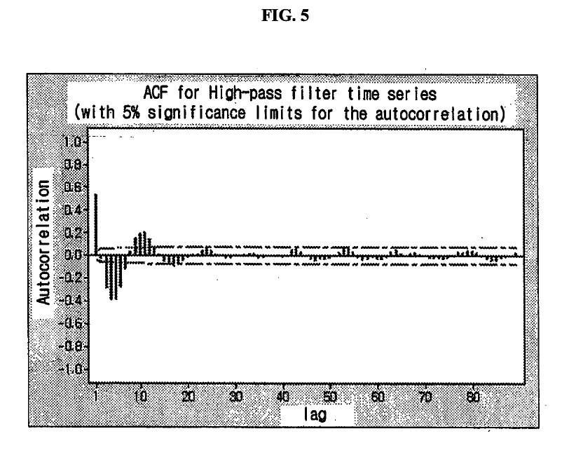

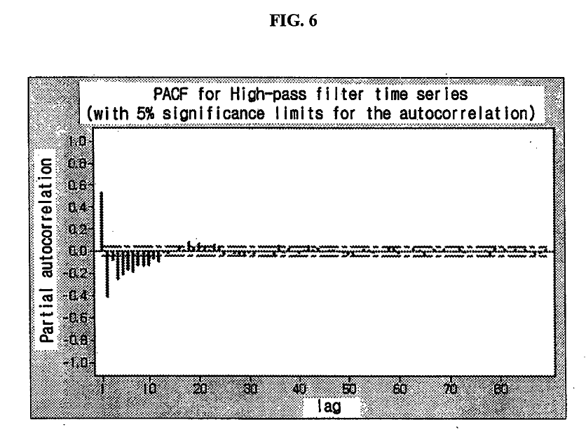

FIG. 5 is a graph illustrating the autocorrelation distribution of a residual component in a time series, and FIG. 6 is a graph illustrating the partial autocorrelation distribution of a residual component in a time series.

As for the ARMA model, an ARMA (1, 1) which is an appropriate type for a time series exhibiting the auto regressive property as well as the moving average property can be selected.

Next, to estimate coefficients of the Equation 2, one of the moments method, MLM (Maximum Likelihood Method), and the least square method may be used.

After a parameter for the ACF, PACF based time series model is determined (S124), the independence and normality of the residual component are examined to verify if the time series model is appropriate for the forecasting (S126).

Next, the time series model is applied to the residual component (S130) to detect an anomaly (S140). The anomaly detecting step (S140) may be accomplished by calculating a confidence limit around a predicted value of the time series model to set up a normal range, and acknowledging the existence of an anomaly if the time series of the residual component falls outside the normal range.

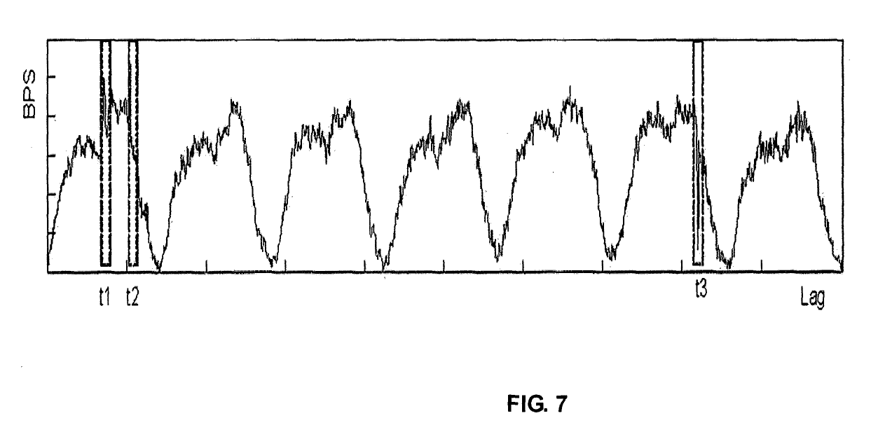

The following will now explain about the compatibility of a time series model, with reference to FIGS. 7 through 11.

FIG. 7 is a graph illustrating ISP network traffic data as a test target.

As can be seen in the graph, one can identify more than three anomalies that show a sudden, sharp increase and a sudden, sharp decrease in t₁, t₂, and t₃ intervals.

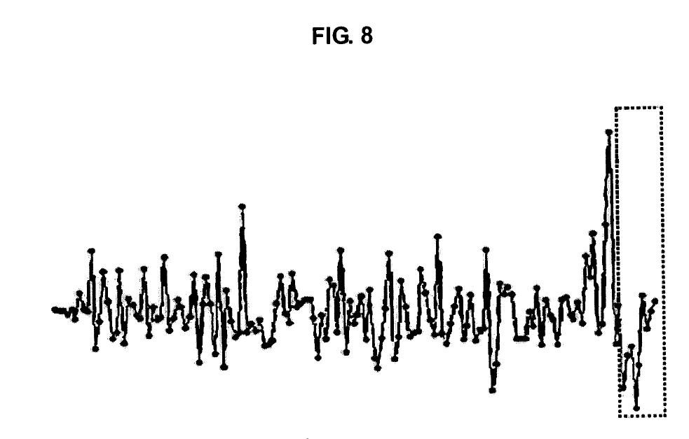

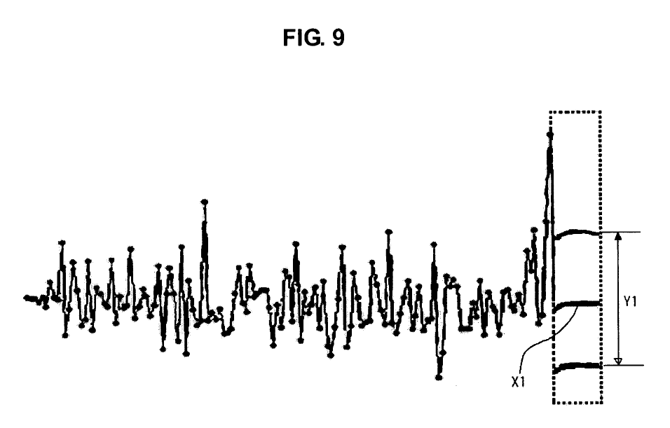

FIG. 8 is a result graph illustrating part of the ISP network traffic data of FIG. 7 filtered by a high pass filter according to one embodiment of the present invention, and FIG. 9 is a graph illustrating a normal range set up by an ARMA model according to one embodiment of the present invention. In FIG. 9, the ARMA model forecasts a predicted value (X1) with 95% confidence limit, and sets a normal range (Y1) within t₁ interval. Comparing a blocked area in FIG. 8 with a blocked area in FIG. 9, one can see that the time series of the residual component is restored to normal after the sudden, sharp increase, falling into the normal range (Y1) having been predicted by the ARMA model. That is to say, the ARMA model according to one embodiment of the present invention is not only capable of detecting the occurrence of anomalies, but also capable of accurately forecasting the normal range (Y1) of the time series after the anomalies have occurred.

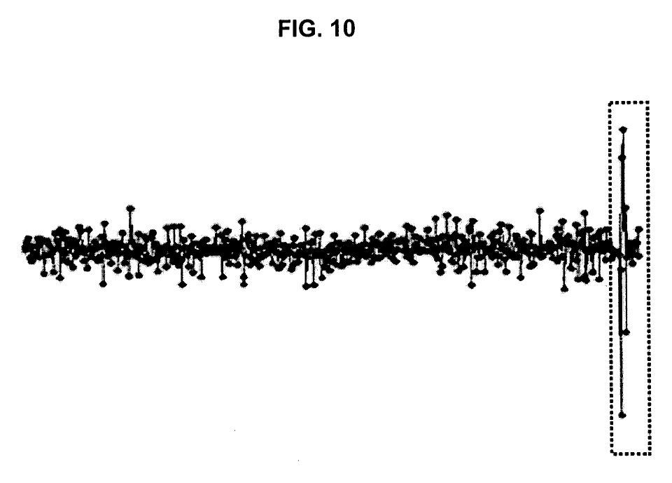

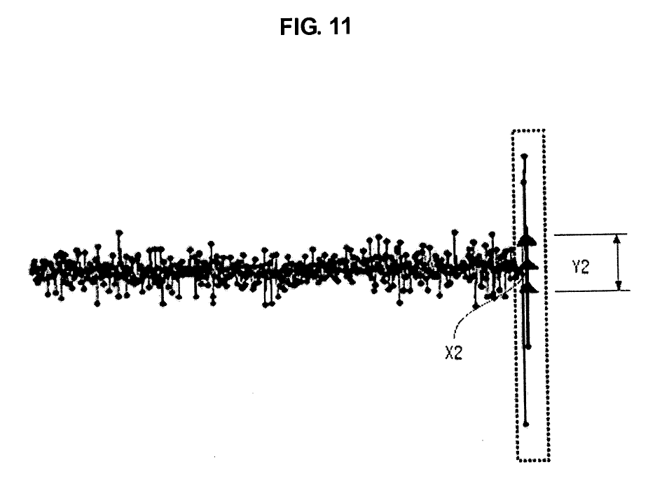

FIG. 10 is another example of a result graph illustrating part of the ISP network traffic data of FIG. 7 filtered by a high pass filter according to one embodiment of the present invention, and FIG. 11 is another example of a graph illustrating a normal range set up by an ARMA model according to one embodiment of the present invention. In FIG. 11, the ARMA model forecasts a predicted value (X2) with 95% confidence limit, and sets a normal range (Y2) within t₃ interval. Comparing a blocked area in FIG. 11 with a blocked area in FIG. 12, one can see that the time series of the residual component is restored to normal after the sudden, sharp decrease, falling into the normal range (Y2) having been predicted by the ARMA model.

While the present invention has been described with respect to certain preferred embodiments, it will be apparent to those skilled in the art that various changes and modifications may be made without departing from the scope of the invention as defined in the following claims.

What is claimed is:

1. A method for detecting a network attack based on a time series analysis on network traffic data, comprising the steps of:
a) removing a trend component from the time series data to extract a residual component; and
b) detecting an anomaly by applying a time series model to the residual component.

2. The method of claim 1, wherein the trend component removing step a) is carried out by using a signal filter.

3. The method of claim 2, wherein the signal filter comprises a high-pass filter.

4. The method of claim 1, wherein the anomaly detecting step b) includes the steps of:
b1) calculating a confidence limit around a predicted value of the time series model to set a normal range; and
b2) acknowledging the existence of an anomaly if the time series of the residual component falls outside the normal range.

5. The method of claim 1, wherein the time series model comprises an ARMA model.

6. The method of claim 1, further comprising, between the trend component removing step a) and the anomaly detecting step b), the steps of:
analyzing a constant variance over time of the time series of the residual component to select a time series model; and
determining a parameter for the time series model based on ACF (Autocorrelation Function) and PACF (Partial Autocorrelation Function).
